(19) United States
(12) Patent Application Publication
(10) Pub. No.: US 2012/0327381 A1
(43) Pub. Date: Dec. 27, 2012

(54) Radiation Source, Lithographic Apparatus and Device Manufacturing Method

(75) Inventors: Dzmitry Labetski, Utrecht (NL); Vadim Yevgenyevich Banine, Deurne (NL); Erik Roelof Loopstra, Eindhoven (NL); Andrei Mikhailovich Yakunin, Eindhoven (NL)

(73) Assignee: ASML Netherlands B.V., Veldhoven (NL)

(21) Appl. No.: 13/582,261

(22) PCT Filed: Jan. 31, 2011
(86) PCT No.: PCT/EP2011/051334

§ 371 Date: Aug. 31, 2012

Related U.S. Application Data
(60) Provisional application No. 61/313,452, filed on Mar. 12, 2010.
(60) Provisional application No. 61/348,477, filed on May 26, 2010.

(51) Int. Cl. G03B 27/52

(52) U.S. Cl. 355/30

(57) ABSTRACT

A radiation source for generating extreme ultraviolet radiation for a lithographic apparatus has a debris mitigation device comprising a nozzle arranged at or near an intermediate focus (IF) of the beam of radiation. The nozzle serves to direct a flow of gas (330) towards the radiation source or collector optic in order to deflect particulate debris (43) emitted by the radiation source.

### CROSS REFERENCE TO RELATED APPLICATIONS

This application claims the benefit of U.S. provisional applications 61/313,452 and 61/348,477, which were filed on 12 Mar. 2010 and on 26 May 2010 respectively, and which are incorporated herein in their entirety by reference.

### BACKGROUND

1. Field

Embodiments of the present invention relate to a radiation source, particularly for use in lithography, a lithographic apparatus and a method for manufacturing a device.

2. Background

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g., including part of, one, or several dies) on a substrate (e.g., a silicon wafer). Transfer of the pattern is typically via imaging onto a layer of radiation-sensitive material (resist) provided on the substrate. In general, a single substrate will contain a network of adjacent target portions that are successively patterned.

Lithography is widely recognized as one of the key steps in the manufacture of ICs and other devices and/or structures. However, as the dimensions of features made using lithography become smaller, lithography is becoming a more critical factor for enabling miniature IC or other devices and/or structures to be manufactured.

A theoretical estimate of the limits of pattern printing can be given by the Rayleigh criterion for resolution as shown in equation (1):

$$CD = {k}_{1} * \frac{λ}{NA} \qquad ( 1 )$$

where λ is the wavelength of the radiation used, NA is the numerical aperture of the projection system used to print the pattern, k1 is a process dependent adjustment factor, also called the Rayleigh constant, and CD is the feature size (or critical dimension) of the printed feature. It follows from equation (1) that reduction of the minimum printable size of features can be obtained in three ways: by shortening the exposure wavelength λ, by increasing the numerical aperture NA or by decreasing the value of k₁.

In order to shorten the exposure wavelength and, thus, reduce the minimum printable size, it has been proposed to use an extreme ultraviolet (EUV) radiation source. EUV radiation is electromagnetic radiation having a wavelength within the range of 10-20 nm, for example within the range of 13-14 nm It has further been proposed that EUV radiation with a wavelength of less than 10 nm could be used, for example within the range of 5-10 nm such as 6.7 nm or 6.8 nm. Such radiation is termed extreme ultraviolet radiation or soft x-ray radiation. Possible sources include, for example, laser-produced plasma sources, discharge plasma sources, or sources based on synchrotron radiation provided by an electron storage ring.

EUV radiation may be produced using a plasma. A radiation system for producing EUV radiation may include a laser for exciting a fuel to provide the plasma, and a source collector module for containing the plasma. The plasma may be created, for example, by directing a laser beam at a fuel, such as particles of a suitable material (e.g., tin), or a stream of a suitable gas or vapor, such as Xe gas or Li vapor. The resulting plasma emits output radiation, e.g., EUV radiation, which is collected using a radiation collector. The radiation collector may be a mirrored normal incidence radiation collector, which receives the radiation and focuses the radiation into a beam. The source collector module may include an enclosing structure or chamber arranged to provide a vacuum environment to support the plasma. Such a radiation system is typically termed a laser produced plasma (LPP) source.

In a typically laser produced plasma source, droplets of the fuel (e.g., tin) are irradiated by a pulsed laser beam with sufficient power that they are turned into a plasma in a hydrogen atmosphere. The hydrogen atmosphere is at a relatively low pressure, e.g., 20-30 mbar, and is arranged to flow from a droplet generator towards a droplet catcher in order to stabilize the transport of the droplets and assist in confining the fuel as it is turned into a plasma. However, formation of the plasma can result in formation of a very large number (about 10⁷) of small tin particulate debris, of typical sizes about 200 nm This debris is emitted in all directions and a significant part thereof travels towards the intermediate focus and then into the illumination system. Within the illumination system, tin can be deposited on the mirrors. Any tin that deposits on the minors can result in a significant loss of reflectivity and otherwise damage the multilayer coatings. Such deposited tin is hard to remove.

### BRIEF SUMMARY

A radiation source device is provided in which problems of the prior art are alleviated or solved, and in particular in which the amount of particulate debris entering into the illumination system of a lithographic apparatus is reduced.

According to an aspect, there is provided a radiation source device for supplying a beam of extreme ultraviolet radiation to a lithographic apparatus, the radiation source device including: a vacuum chamber enclosing a radiation generating element; a radiation collector arranged to collect radiation emitted by the radiation generating element and form it into a radiation beam directed to an intermediate focus; and a debris mitigation device arranged near the intermediate focus and connected to a gas source, the debris mitigation device including a nozzle arranged to direct gas supplied by the source into a gas flow toward the radiation generating element or the radiation collector, the gas flow being sufficient to deflect or retard particulate debris moving towards the intermediate focus.

According to another aspect, there is provided a radiation source device including a vacuum chamber enclosing a radiation generating element, a radiation collector arranged to collect radiation emitted by the radiation generating element and form the collected radiation into a radiation beam directed to an intermediate focus, and a debris mitigation device arranged near the intermediate focus and connected to a gas source, the debris mitigation device comprising a nozzle arranged to direct gas supplied by the source into a gas flow toward the radiation generating element or the radiation collector, the gas flow being sufficient to deflect or retard particulate debris moving toward the intermediate focus.

The intermediate focus may be at or near an aperture in the vacuum chamber. The vacuum chamber may have a cone-shaped wall section surrounding the aperture. The nozzle may be annular and may be located so as to surround the radiation beam. The debris mitigation device may include a plurality of nozzles arranged around the radiation beam. The plurality of nozzles may consist of 3, 4, 5, or 6 nozzles.

The debris mitigation device may further include a debris catching device arranged to collect debris deflected by the gas flow. The debris collecting device may include a plurality of plates arranged to collect the debris. The plates may be arranged in a region of the vacuum chamber traversed by the radiation beam before the intermediate focus, the plates being arranged substantially parallel to a direction of propagation of the radiation beam. The plurality of plates may be located in a region of the vacuum chamber not traversed by the radiation beam and may be arranged substantially perpendicular to a direction of propagation of the radiation beam. The plurality of plates may be mounted on a wall of the vacuum chamber. The debris catching device may include a plurality of cavities formed on a wall of the vacuum chamber.

A pressure of gas supplied by the gas source and a shape of the nozzle may be selected such that a rate of flow of gas leaving the nozzle is greater than or equal to about 10 standard liters per minute (slm). A pressure of gas in the gas source and a shape of the nozzle may be selected such that a rate of flow of gas leaving the nozzle is less than or equal to about 15 slm. A pressure of gas supplied by the gas source and a shape of the nozzle may be arranged so that a velocity of the gas in a zone of the vacuum chamber traversed by the projection beam is greater than about 500 m/s, desirably greater than about 1000 m/s.

The debris mitigation device further may include a heater configured to provide heat to a downstream region traversed by the radiation beam after the nozzle. The heater is preferably configured to heat gas in the downstream region to a temperature in the range of 300 to 1000° C., more preferably 400 to 800° C., even more preferably 500 to 700° C. The debris mitigation device may further include a gas outlet arranged further from the collector than is the nozzle. The gas may be selected from the group consisting of hydrogen, deuterium, tritium and helium. The radiation generating element may be a plasma source, such as a laser-produced plasma source. The laser-produced plasma source may include a droplet generating device arranged to generate droplets of a fuel and a laser device arranged to irradiate the droplets. The droplet generator may be arranged to generate droplets of tin.

According to another embodiment of the present invention, there is provided a lithographic apparatus, such as a lithographic apparatus for projecting a patterned beam onto a substrate, the apparatus including: a vacuum chamber enclosing a radiation generating element; a radiation collector arranged to collect radiation emitted by the radiation generating element and form it into a radiation beam directed to an intermediate focus; a debris mitigation device arranged near the intermediate focus and connected to a gas source, the debris mitigation device including a nozzle arranged to direct gas supplied by the source into a gas flow toward the radiation generating element or the radiation collector; and an illumination system positioned after the intermediate focus and arranged to condition and direct the radiation beam onto a patterning means, the gas flow being sufficient to deflect or retard particulate debris moving towards the intermediate focus.

According to an embodiment of the lithographic apparatus, the vacuum chamber has a first aperture and a first cone-shaped wall section surrounding the first aperture, the illumination system is contained within a second vacuum chamber having a second aperture and a second cone-shaped wall section surrounding the second aperture, and the first and second cone-shaped wall sections are connected together to connect the vacuum chamber to the second vacuum chamber and allow the radiation beam to propagate to the illumination system. The nozzle may be provided in the first cone-shaped wall section. A gas outlet may be provided in the second cone-shaped wall-section. A heater may be provided in at least one of the first and second cone-shaped wall sections further from the collector than is the nozzle. A neck may be formed by the first and second cone-shaped wall sections where they are connected.

According to another embodiment of the present invention there is provided a device manufacturing method using a lithographic apparatus, the method including: generating radiation using a radiation source; collecting the radiation and directing it to an intermediate focus to form a radiation beam; imparting a pattern onto the radiation beam using a patterning means; projecting the patterned radiation beam onto a substrate; and directing a flow of hydrogen towards the source from a nozzle located near the intermediate focus, the gas flow being sufficient to deflect or retard particulate debris moving towards the intermediate focus.

Further features and advantages of embodiments of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 depicts a lithographic apparatus, according to an embodiment of the invention.

FIG. 2 is a more detailed view of the apparatus of FIG. 1, according to an embodiment of the invention.

FIG. 3 is a more detailed view of the source collector module SO of the apparatus of FIGS. 1 and 2, according to an embodiment of the invention.

FIG. 4 is a schematic diagram used in explaining the problem addressed by embodiments of the present invention.

FIG. 5 is a schematic diagram illustrating the principle of operation of an embodiment of the present invention.

FIGS. 6 to 10 are schematic cross-sectional views of parts of various embodiments of the invention.

FIGS. 11 and 12 are graphs showing the variation of particle stopping power with gas flow velocity, pressure and length of particle stopping region.

FIGS. 13 and 14 are schematic cross-sectional views of parts of various embodiments of the invention.

The features and advantages of embodiments of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Before describing such embodiments in more detail, however, it is instructive to present an example environment in which embodiments of the present invention may be implemented.

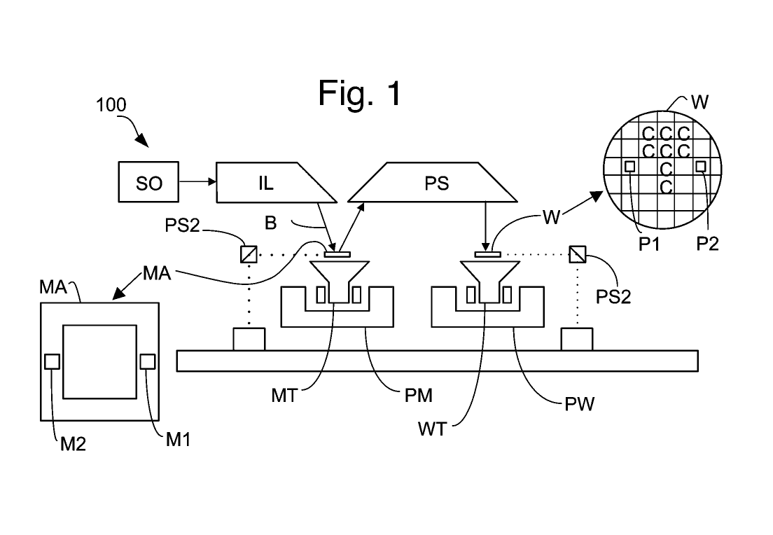

FIG. 1 schematically depicts a lithographic apparatus 100 including a source collector module SO according to one embodiment of the invention. The apparatus includes an illumination system (illuminator) IL configured to condition a radiation beam B (e.g., EUV radiation), a support structure (e.g., a mask table) MT constructed to support a patterning device (e.g., a mask or a reticle) MA and connected to a first positioner PM configured to accurately position the patterning device, a substrate table (e.g., a wafer table) WT constructed to hold a substrate (e.g., a resist coated wafer) W and connected to a second positioner PW configured to accurately position the substrate, and a projection system (e.g., a reflective projection system) PS configured to project a pattern imparted to the radiation beam B by patterning device MA onto a target portion C (e.g., including one or more dies) of the substrate W.

The illumination system may include various types of optical components for directing, shaping, or controlling radiation.

The support structure MT holds the patterning device MA in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system.

The term “patterning device” should be broadly interpreted as referring to any device that can be used to impart a radiation beam with a pattern in its cross-section such as to create a pattern in a target portion of the substrate. The pattern imparted to the radiation beam may correspond to a particular functional layer in a device being created in the target portion, such as an integrated circuit.

The patterning device may be transmissive or reflective. Examples of patterning devices include masks, programmable minor arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the minor matrix.

The projection system, like the illumination system, may include various types of optical components. It may be desired to use a vacuum for EUV radiation since other gases may absorb too much radiation. A vacuum environment may therefore be provided to the whole beam path with the aid of a vacuum wall and vacuum pumps.

As here depicted, the apparatus is of a reflective type (e.g., employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

Referring to FIG. 1, the illuminator IL receives an extreme ultraviolet (EUV) radiation beam from the source collector module SO. Methods to produce EUV radiation include, but are not necessarily limited to, converting a material into a plasma state that has at least one element, e.g., xenon, lithium or tin, with one or more emission lines in the EUV range. In one such method, often termed laser produced plasma (“LPP”) the required plasma can be produced by irradiating a fuel, such as a droplet, stream or cluster of material having the required line-emitting element, with a laser beam. The source collector module SO may be part of an EUV radiation system including a laser, not shown in FIG. 1, for providing the laser beam exciting the fuel. The resulting plasma emits output radiation, e.g., EUV radiation, which is collected using a radiation collector, disposed in the source collector module. The laser and the source collector module may be separate entities, for example when a CO₂ laser is used to provide the laser beam for fuel excitation.

In such cases, the laser is not considered to form part of the lithographic apparatus and the radiation beam is passed from the laser to the source collector module with the aid of a beam delivery system including, for example, suitable directing mirrors and/or a beam expander. In other cases the source may be an integral part of the source collector module, for example when the source is a discharge produced plasma EUV generator, often termed as a DPP source.

The illuminator IL may include an adjuster for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may include various other components, such as facetted field and pupil mirror devices. The illuminator may be used to condition the radiation beam, to have a desired uniformity and intensity distribution in its cross section.

The radiation beam B is incident on the patterning device (e.g., mask) MA, which is held on the support structure (e.g., mask table) MT, and is patterned by the patterning device. After being reflected from the patterning device (e.g., mask) MA, the radiation beam B passes through the projection system PS, which focuses the beam onto a target portion C of the substrate W. With the aid of the second positioner PW and position sensor PS2 (e.g., an interferometric device, linear encoder or capacitive sensor), the substrate table WT can be moved accurately, e.g., so as to position different target portions C in the path of the radiation beam B. Similarly, the first positioner PM and another position sensor PS1 can be used to accurately position the patterning device (e.g., mask) MA with respect to the path of the radiation beam B. Patterning device (e.g., mask) MA and substrate W may be aligned using mask alignment marks M1, M2 and substrate alignment marks P1, P2.

The depicted apparatus could be used in at least one of the following modes:

1. In step mode, the support structure (e.g., mask table) MT and the substrate table WT are kept essentially stationary, while an entire pattern imparted to the radiation beam is projected onto a target portion C at one time (i.e., a single static exposure). The substrate table WT is then shifted in the X and/or Y direction so that a different target portion C can be exposed.

2. In scan mode, the support structure (e.g., mask table) MT and the substrate table WT are scanned synchronously while a pattern imparted to the radiation beam is projected onto a target portion C (i.e., a single dynamic exposure). The velocity and direction of the substrate table WT relative to the support structure (e.g., mask table) MT may be determined by the (de-)magnification and image reversal characteristics of the projection system PS.

3. In another mode, the support structure (e.g., mask table) MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

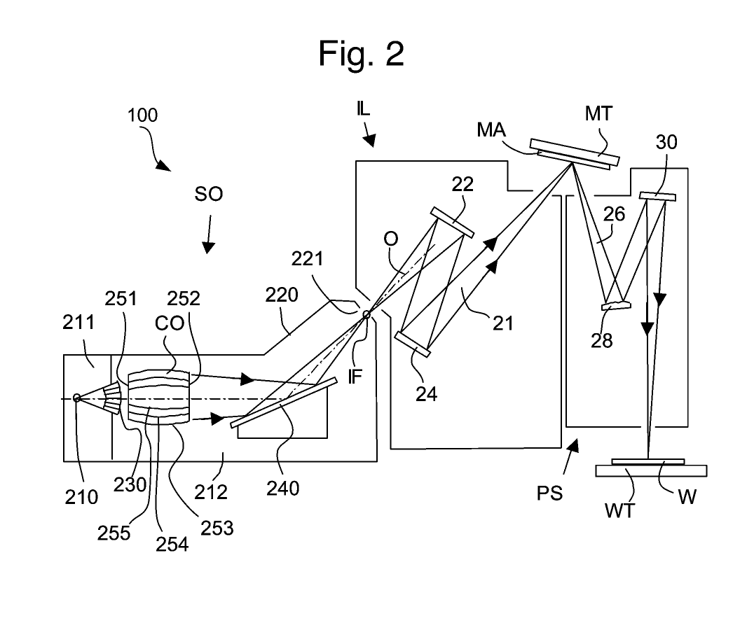

FIG. 2 shows the apparatus 100 in more detail, including the source collector module SO, the illumination system IL, and the projection system PS. The source collector module SO is constructed and arranged such that a vacuum environment can be maintained in an enclosing structure 220 of the source collector module SO. An EUV radiation emitting plasma 210 may be formed by a discharge produced plasma source. EUV radiation may be produced by a gas or vapor, for example Xe gas, Li vapor or Sn vapor in which the very hot plasma 210 is created to emit radiation in the EUV range of the electromagnetic spectrum. The very hot plasma 210 is created by, for example, an electrical discharge causing an at least partially ionized plasma. Partial pressures of, for example, 10 Pa of Xe, Li, Sn vapor or any other suitable gas or vapor may be required for efficient generation of the radiation. In an embodiment, a plasma of excited tin (Sn) is provided to produce EUV radiation.

The radiation emitted by the hot plasma 210 is passed from a source chamber 211 into a collector chamber 212 via an optional gas barrier or contaminant trap 230 (in some cases also referred to as contaminant barrier or foil trap) which is positioned in or behind an opening in source chamber 211. The contaminant trap 230 may include a channel structure. Contamination trap 230 may also include a gas barrier or a combination of a gas barrier and a channel structure. The contaminant trap or contaminant barrier 230 further indicated herein at least includes a channel structure, as known in the art.

The collector chamber 211 may include a radiation collector CO which may be a so-called grazing incidence collector. Radiation collector CO has an upstream radiation collector side 251 and a downstream radiation collector side 252. Radiation that traverses collector CO can be reflected off a grating spectral filter 240 to be focused in a virtual source point IF. The virtual source point IF is commonly referred to as the intermediate focus, and the source collector module is arranged such that the intermediate focus IF is located at or near an opening 221 in the enclosing structure 220. The virtual source point IF is an image of the radiation emitting plasma 210.

Subsequently the radiation traverses the illumination system IL, which may include a facetted field mirror device 22 and a facetted pupil mirror device 24 arranged to provide a desired angular distribution of the radiation beam 21, at the patterning device MA, as well as a desired uniformity of radiation intensity at the patterning device MA. Upon reflection of the beam of radiation 21 at the patterning device MA, held by the support structure MT, a patterned beam 26 is formed and the patterned beam 26 is imaged by the projection system PS via reflective elements 28, 30 onto a substrate W held by the wafer stage or substrate table WT.

More elements than shown may generally be present in illumination optics unit IL and projection system PS. The grating spectral filter 240 may optionally be present, depending upon the type of lithographic apparatus. Further, there may be more mirrors present than those shown in the Figures, for example there may be 1-6 additional reflective elements present in the projection system PS than shown in FIG. 2.

Collector optic CO, as illustrated in FIG. 2, is depicted as a nested collector with grazing incidence reflectors 253, 254 and 255, just as an example of a collector (or collector mirror). The grazing incidence reflectors 253, 254 and 255 are disposed axially symmetric around an optical axis O and a collector optic CO of this type is used in combination with a discharge produced plasma source, often called a DPP source.

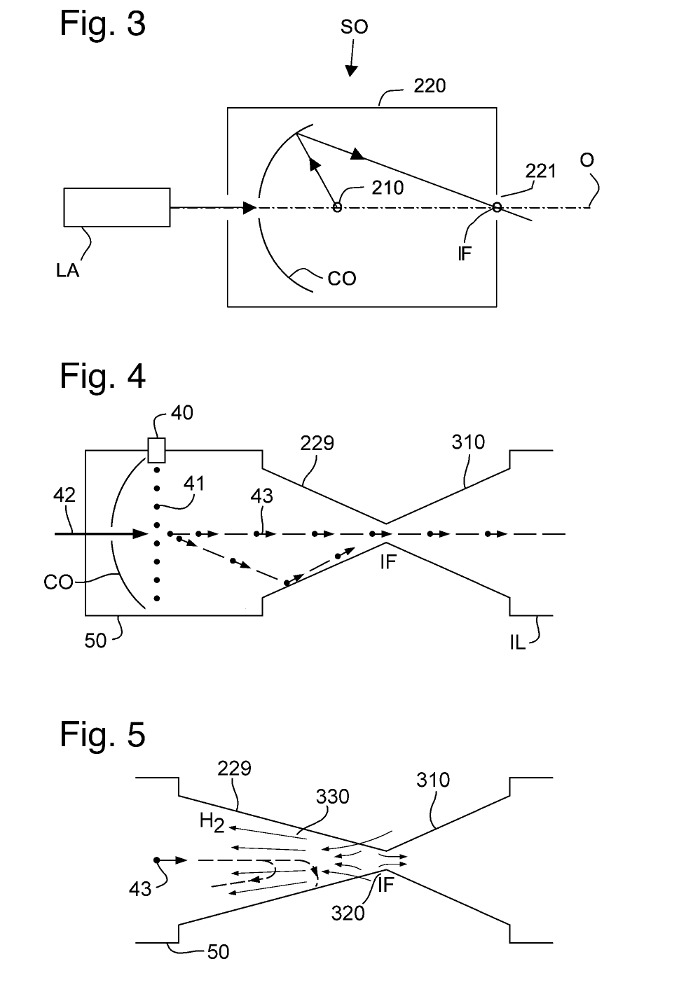

Alternatively, the source collector module SO may be part of an LPP radiation system as shown in FIG. 3. A laser LA is arranged to deposit laser energy into a fuel, such as xenon (Xe), tin (Sn) or lithium (Li), creating the highly ionized plasma 210 with electron temperatures of several 10's of eV. The energetic radiation generated during de-excitation and recombination of these ions is emitted from the plasma, collected by a near normal incidence collector optic CO and focused onto the opening 221 in the enclosing structure 220.

In an EUV lithographic apparatus the source module, illumination system and projection system, as well as any other parts traversed by the projection beam are usually provided with a low pressure (e.g. 20-30 mbar) hydrogen environment, because hydrogen has a low absorption coefficient to EUV radiation and also helps to clean any carbon and tin deposits off parts of the apparatus. However, other gases, such as helium, can be used instead, in which case an alternative protective compound might be appropriate.

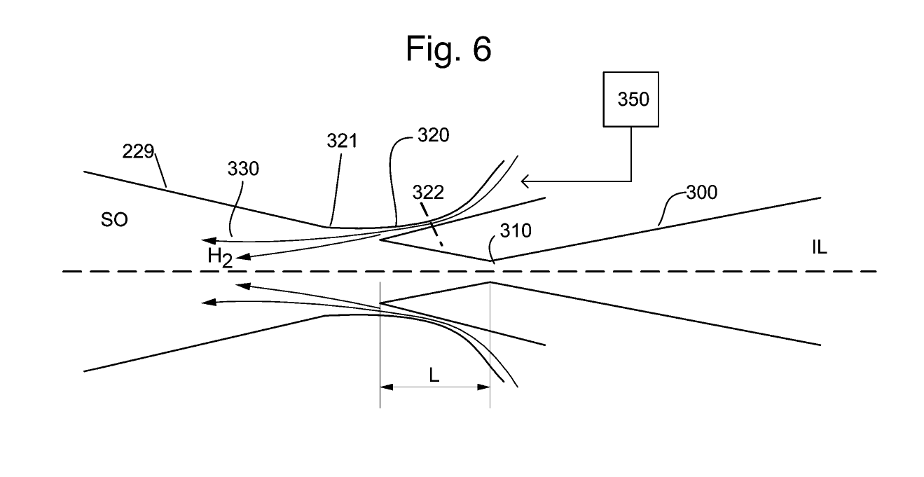

FIG. 4 is a schematic diagram of a laser-produced plasma source illustrating a problem of such sources that is addressed by embodiments of the present invention. In such a source, a droplet generator 40 emits droplets 41 of molten fuel, e.g. tin (Sn) which may be for example of diameter about 20-50 nm. These droplets fall along a known trajectory, and may be entrained in a flow of hydrogen gas emitted by a source (not shown) near the droplet generator and removed by an outlet near a droplet catcher (not shown). At a predetermined point along the path of the droplets, a pulsed CO₂ laser beam 42 is directed onto each droplet. The pulses of the laser beam are arranged to have sufficient energy to create a plasma from each tin droplet. The plasma emits EUV radiation which is collected by collector optic CO and directed towards an intermediate focus IF. The plasma also emits a large amount of small particulate debris 43 (about 10⁷ particles per droplet), a proportion of which travels towards the intermediate focus and can then enter the rest of the lithographic apparatus, or scanner. Particles may also enter the rest of the lithography apparatus by indirect paths, having been deflected by, e.g., the wall of the source cone 229 or another surface in the source module. Particles 43 are generally around 100-200 nm in size.

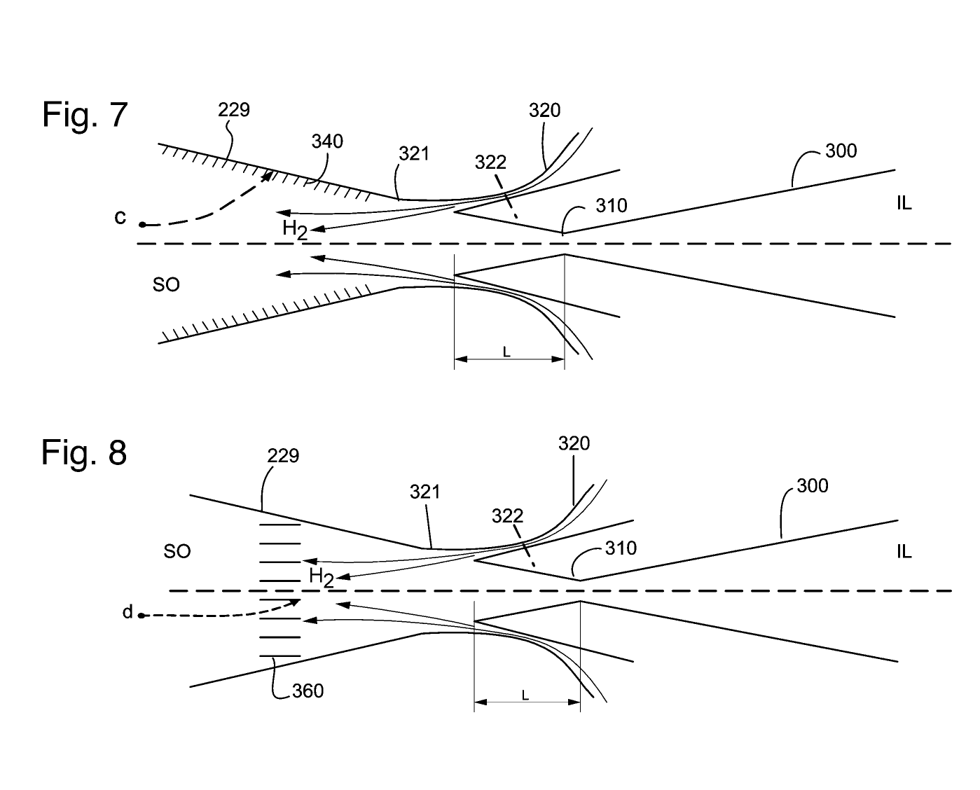

FIG. 5 illustrates a principle of operation of an embodiment of the present invention which aims to at least partially alleviate the above mentioned problem. Both the radiation source and illumination system of the lithographic apparatus are contained within vacuum chambers. To connect these vacuum chambers and allow for the passage of the radiation beam from the source to the illumination module, the respective vacuum chambers are provided with cone-shaped projections which meet at a narrow neck 310. These may be referred to respectively as the source cone 229 and scanner cone 300 but need not be exactly cone-shaped. The intermediate focus formed by collector optics CO is located at or near the neck formed by the junction of the source cone and scanner cone. The source cone and scanner cone therefore can take any shape which conveniently minimizes the volume of the vacuum chamber without significantly obstructing the radiation beam. Any deviations from an ideal cone closely surrounding the converging and diverging parts of the radiation beam may therefore be made for structural or manufacturing reasons.

According to an embodiment of the invention, one or more openings, e.g nozzles or slits, are provided at a convenient location on the source cone at or near the intermediate focus. The opening or openings are arranged to create a high velocity flow of gas 330 towards the source or collector optic CO, i.e., up beam or in the opposite direction to the direction of propagation of the radiation beam. In an embodiment, the gas is H₂, but deuterium, tritium or helium may also be used, for example. The flow of gas may be sufficient to cause a tin particle 43 traveling towards intermediate focus IF to turn back (trajectory a) or be deflected to the wall of the source cone 229 (trajectory b).

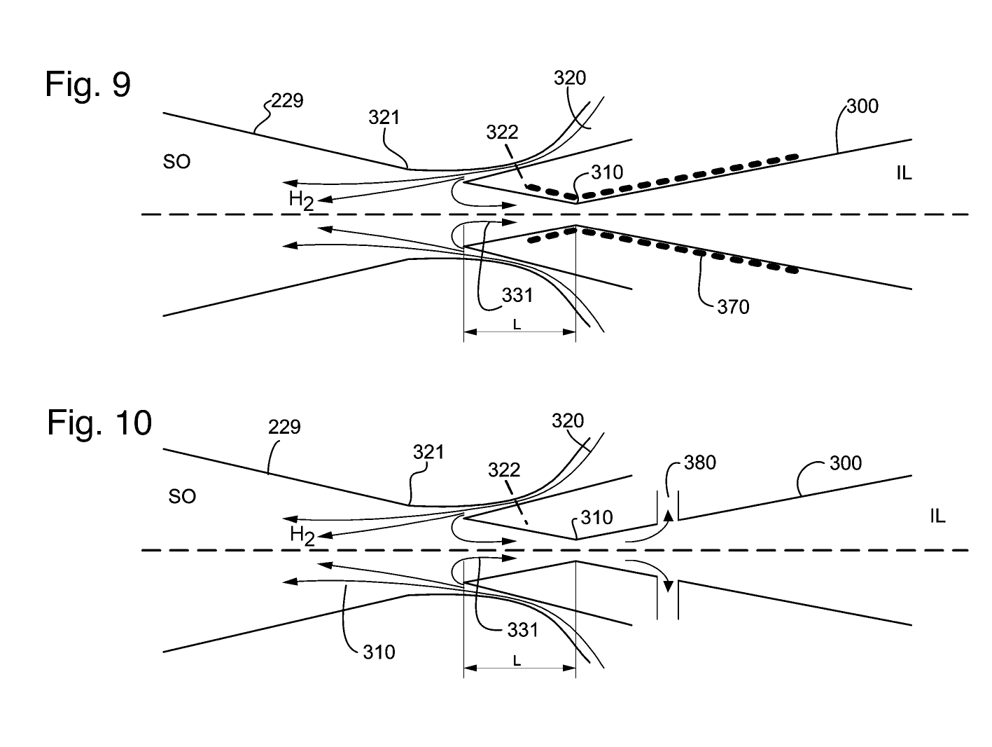

FIG. 6 shows in more detail relevant parts of a practical embodiment of the present invention. As can be clearly be seen therein, the source cone 229 and scanner cone 300 meet at a neck 310 at which is located at the intermediate focus of the radiation beam B. A slit 320 is provided in the wall of the scanner cone 229 to create a flow 330 of gas towards the source module. Gas is supplied to the slit 320 from a gas supply 350. Slit 320 may be a complete annular slit around source cone 229 or a plurality of discrete openings arranged around the source cone 229. Each of such a plurality of openings (e.g., 3 to 6) may be a slit or a circular nozzle. The rate of flow of gas out of slit 320 may be in the range of from about 3 to about 70 slm (standard liters per minute), desirably from about 10 to about 15 slm (standard liters per minute). A flow rate of about 3 slm has been found to be sufficient to stop tin particles of average diameter 200 nm with a velocity of up to 120 meters per second in a typical source pressure of about 100 Pa. A rate of about 10 slm stops 200 nm particles with a velocity up to 300 m/s under the same conditions. Increasing the flow rate increases the size and speed of particles that are stopped. However, above a flow rate of about 15 slm the leakage of gas into the illumination system IL increases and it becomes necessary to improve the vacuum system thereof to deal with the increased gas flow.

In an embodiment, the nozzle 320 is close to the intermediate focus. In an embodiment the distance between the nozzle 320 and neck 310 at which the intermediate focus is positioned is in the range of from about 5 mm to about 50 mm, e.g., 10 mm. In an embodiment, the geometry of nozzle 320 is such that it has a narrowest part 322 at which the flow of gas has a velocity equal to the speed of sound in the gas. After the narrowest part 322 the nozzle flares so that the gas flow entering the scanner cone 229 is supersonic. In another embodiment the narrowest part of the nozzle is at the exit. In that case the gas flow is at the speed of sound. It is desirable that the gas flow be as high as possible within the source cone. In an embodiment, the junction 321 between the nozzle opening 320 and scanner cone 229 is smooth so as to avoid any turbulence or instabilities in the gas flow.

FIG. 7 depicts relevant parts of a further embodiment of the present invention the further embodiment being similar to the first embodiment described above save as mentioned below. In this embodiment, a series of cavities 340 are provided on the interior surface of scanner cone 229. These cavities are effective to trap a particle deflected into the wall of scanner cone 229 by gas flow 330, as shown by trajectory c. The cavities act to prevent such a particle bouncing off the scanner cone wall and improve the particle deflecting effect of the present invention. Cavities 340 may be formed by shaping the inner surface of the scanner cone wall or by attaching a plurality of members, e.g., plates, thereto.

FIG. 8 depicts relevant parts of a yet further embodiment of the present invention which may similar to the first embodiment described above except as mentioned below. In this embodiment, a plurality of plates 360 are provided inside the scanner cone 229 in a region traversed by the projection beam B. The plates 360 are arranged substantially parallel to the direction of propagation of beam B. Although shown in FIG. 8 as parallel to one another they may in practice be arranged to point directly towards the intermediate focus. In other words the plates 360 may be arranged so that if extended they would intersect at the intermediate focus. Plates 360 are arranged so that a particle d deflected by the gas flow only a small amount 330 from a straight course towards the intermediate focus will impact one of the plates 360 and adhere thereto. The plates 360 and their supporting structure may be arranged to minimize absorption of the projection beam B.

FIG. 9 depicts relevant parts of yet another further embodiment of the present invention which may be similar to the first or second embodiment described above save as mentioned below. In this embodiment, a heater 370 is provided on parts of the source cone 229 and/or scanner cone 300 downstream of the nozzle 320. The heater 370 is effective to heat any gas located within the source cone and scanner cone downstream of the nozzle 320. The gas in this region may be heated to a temperature of about 300° C. to 1000° C. In an embodiment, the gas is heated to a temperature of about 400° C. to 800° C. In a further embodiment, the gas is heated to a temperature of about 500° C. to 700° C. By heating the gas in the region of the intermediate focus, the flow resistance in this region is increased. This therefore reduces the amount of the gas emitted from nozzle 320 that flows back towards the intermediate focus rather than the desired direction of towards the source and collector. By minimizing the back gas flow 331, the effectiveness of the gas emitted by nozzle 320 to deflect particles is increased.

FIG. 10 depicts relevant parts of a yet again another embodiment of the present invention which may be similar to the first, second and third embodiments described above save as mentioned below. In this embodiment a gas outlet 380 is provided in scanner cone 300 downstream of the neck 310. Gas outlet 380 serves to remove at least a part of the gas flow 331 that enters the scanner cone and therefore prevents an undesirable increase in the gas containing the illumination module vacuum chamber. Gas outlets 380 may be connected to a vacuum pump (not shown). In an embodiment, gas outlet 380 is positioned as close as possible to the neck 310 so that the gas flow 331 is at a relatively high pressure and is therefore more easily removed.

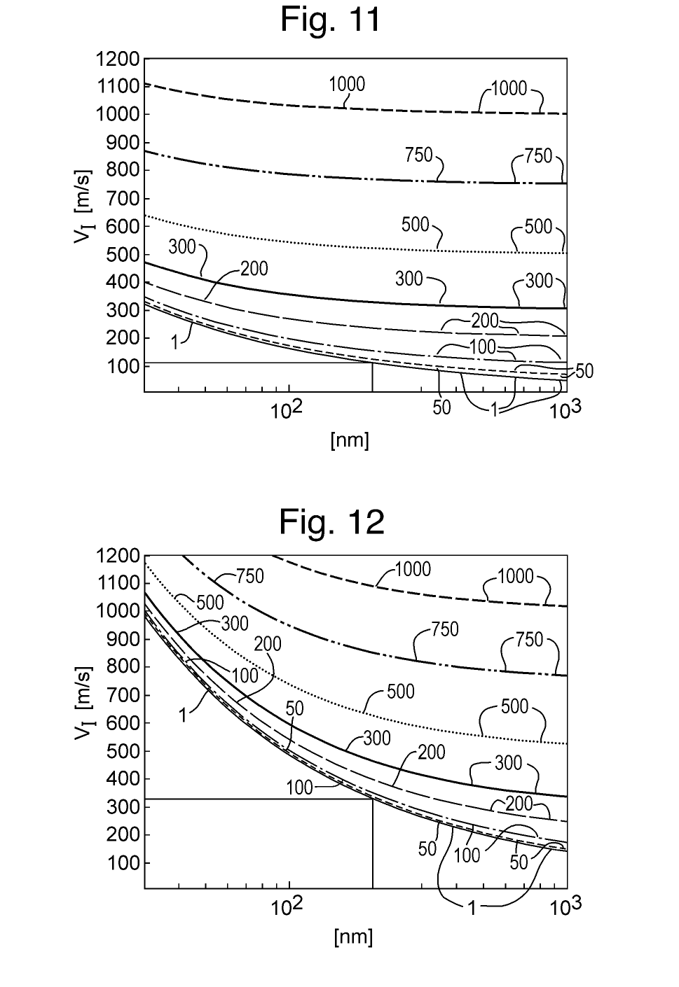

The inventors have determined that higher gas flow rates, higher pressures, and an increase extent of the blocking gas flow contribute, independently and in combination, to increasing the particle stopping power of embodiments of the present invention. This is shown in FIGS. 11 and 12.

FIG. 11 shows the stopping power of an embodiment of the invention with a gas flow velocity of 500 m/s at a pressure of 100 Pa over a length of 40 mm The y-axis indicates the initial velocity of a particle V₁ in m/s entering the gas flow and the x-axis indicates the diameter d of the particle. The contour lines give the particle velocity at the end of gas flow region. Thus it can be seen that particles of diameter 200 nm and initial velocity up to 120 m/s will be stopped.

FIG. 12 is an equivalent diagram for an embodiment with a gas flow velocity of 1000 m/s at a pressure of 135 Pa over a length of 120 mm. Here it can be seen that 200 nm particles with an initial speed of up to 315 nm are stopped.

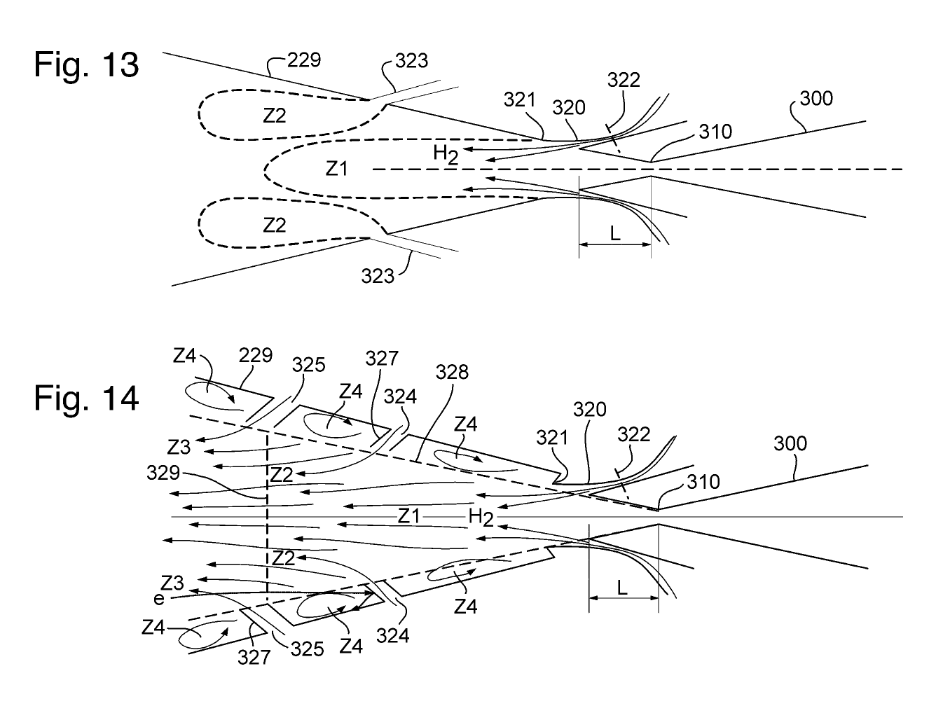

An advanced embodiment of the invention having a debris mitigation device that provides a larger region of high gas flow to deflect debris is shown in FIG. 13. In this embodiment, a second nozzle 323 is provided in the side wall of the source cone 229 and connected to a supply of gas (not shown), for example the same gas supply as nozzle 230. Second nozzle 323 may, like nozzle 320, be a single annular nozzle extending completely around the source cone 229 or a plurality of discrete nozzles or slits spaced around the source cone 229. In use of the device, gas is emitted from second nozzle 323 so as to flow towards the radiation generating elements or radiation collector with sufficient velocity to retard and/or deflect debris emitted by the source plasma.

Second nozzle 323 forms a second deflection zone Z2 surrounding the deflection zone Z1 formed by nozzle 320. The gas flow regions formed by nozzles 320 and 323 can, in some cases, combine to form a single region of high velocity gas flow. In an embodiment, this single region of high velocity gas flow can be larger than the sum of the gas flow regions generated by each nozzle operating independently. By providing additional regions of high velocity gas flow and/or extending the region of high velocity gas flow, particles with a greater initial velocity can be prevented from reaching the intermediate focus IF.

In an embodiment, the nozzle 323 is located at a position where the diameter of the scanner cone 229 is about twice the diameter of the scanner cone at the position of the first nozzle 320. In an embodiment the rate of gas flow through second nozzles 323 is at least about twice the rate of gas flow through first nozzle 320. In an embodiment, a third nozzle (not shown) is provided at a position where the scanner cone diameter has doubled again and emits in use a gas flow at least twice that of the second nozzle 323.

FIG. 14 also shows another advanced embodiment having a debris mitigation device providing a larger region of high velocity gas flow to deflect or retard debris. In this embodiment second nozzle 324 and third nozzle 325 are provided in the source cone between the radiation generating element and/or radiation collector and first nozzle 320. Second nozzle 324 and third nozzle 325 can be single annular slits surrounding or nearly surrounding the source cone. Alternatively either or both of second nozzle 324 and third nozzle 325 can be embodied as a plurality of discreet nozzles or slits spaced around the scanner cone.

Second and third nozzles 324, 325 are connected to one or more gas sources, e.g. the same gas source as is connected to nozzle 320, so as to, in use, emit a high velocity gas flow towards the radiation generating element or radiation collector. The high velocity gas flow retards or deflects debris particles heading towards the intermediate focus IF. As shown in FIG. 14, second nozzle 324 generates a second zone Z2 of high velocity gas and third nozzle 325 generates a third zone Z3 of high velocity gas which supplements the deflecting and retarding effects of high velocity gas zone Z1 formed by nozzle 320. In an embodiment high velocity gas zones Z1, Z2 and Z3 may merge to form one or more larger high velocity gas zones.

As also shown in FIG. 14, second nozzle 324 and third nozzle 325 project inwardly from the side wall of source cone 226. The side walls 327 of second nozzle 324 and third nozzle 325 formed baffles that can prevent a particle bouncing off the wall of scanner cone 229 towards intermediate focus IF, as shown by particle trajectory e in the lower part of FIG. 14. In addition, re-circulating zones Z4 are formed between the nozzles. In re-circulating zones Z4, the gas tends to circulate. The circulating gas can further retard and capture particles entering the zones thereby preventing them reaching the intermediate focus and passing into the scanner cone. It should be noted that second nozzle 324 and third nozzle 325 do not project into the scanner cone as far as the outermost limit of the projection beam, indicated by dashed line 328. In an embodiment, the gas flow rates through successive nozzle 320, 324, 325 increases proportionally to the square of the source cone diameter at the position of the respective nozzle.

In an embodiment, a uniform gas velocity profile is developed across a plane, e.g. indicated by dashed line 329, perpendicular to the axis of the source cone 229.

It will be appreciated that the additional features of the embodiments of FIGS. 7 to 10, 13 and 14 may be combined in any desired combination as required to provide desired performance in an embodiment of the invention.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The term “lens”, where the context allows, may refer to any one or combination of various types of optical components, including refractive, reflective, magnetic, electromagnetic and electrostatic optical components.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A radiation source device for supplying a beam of extreme ultraviolet radiation to a lithographic apparatus, the radiation source device comprising:
a vacuum chamber enclosing a radiation generating element;
a radiation collector arranged to collect radiation emitted by the radiation generating element and form it into a radiation beam directed to an intermediate focus; and
a debris mitigation device arranged near the intermediate focus and connected to a gas source, the debris mitigation device comprising a nozzle arranged to direct gas supplied by the source into a gas flow toward the radiation generating element or the radiation collector, the gas flow being sufficient to deflect or retard particulate debris moving toward the intermediate focus.

2. A radiation source device comprising:
a vacuum chamber enclosing a radiation generating element;
a radiation collector arranged to collect radiation emitted by the radiation generating element and form the collected radiation into a radiation beam directed to an intermediate focus; and
a debris mitigation device arranged near the intermediate focus and connected to a gas source, the debris mitigation device comprising a nozzle arranged to direct gas supplied, by the source into a gas flow toward the radiation generating element or the radiation collector, the gas flow being sufficient to deflect or retard particulate debris moving toward the intermediate focus.

3. The radiation source of claim 1, wherein the debris mitigation device comprises a plurality of nozzles arranged around the radiation beam.

4. The radiation source of claim 1, wherein the debris mitigation device comprises a plurality of nozzles spaced apart in a direction parallel to the radiation beam.

5. The radiation source of claim 4, wherein a first one of the nozzles is arranged. to emit gas at a first gas flow rate and a second one of the nozzles is arranged to emit gas at a second gas flow rate, the second one of the nozzles being further away from the intermediate focus than is the first one of the nozzles and the second gas flow rate being greater than the first gas flow rate.

6. The radiation source of claim 1, wherein the or a nozzle projects inwardly from a wall of the vacuum chamber.

7. The radiation source of claim 1, wherein the debris mitigation device further comprises a debris catching device arranged to collect debris deflected by the gas flow.

8. The radiation source of claim 1, wherein a pressure of gas in the gas source and a shape of the nozzle are selected such that a velocity of gas in the nozzle is about equal to the speed of sound in the gas.

9. The radiation source of claim 1, wherein a pressure of gas supplied by the gas source and a shape of the nozzle are selected such that a velocity of gas leaving the nozzle is supersonic.

10. The radiation source of to claim 1, wherein the debris mitigation device further comprises a heater configured to provide heat to a downstream region traversed by the radiation beam after the nozzle,

11. (canceled)

12. A lithographic apparatus, comprising:
a radiation source device comprising:
a vacuum chamber enclosing a radiation generating element,
a radiation collector arranged to collect radiation emitted by the radiation generating element and form the collected radiation into a radiation beam directed to an intermediate focus, and
a debris mitigation device arranged near the intermediate focus and connected to a gas source, the debris mitigation device comprising a nozzle arranged to direct gas supplied by the source into a gas flow toward the radiation generating element or the radiation collector, the gas flow being sufficient to deflect or retard particulate debris moving toward the intermediate focus;
a patterning device configured to pattern the radiation beam; and
a projection system configured to project the pattered beam onto a substrate.

13. A lithographic apparatus, the apparatus comprising:
a vacuum chamber enclosing a radiation generating element;
a radiation collector arranged to collect radiation emitted by the radiation generating element and form the collected radiation into a radiation beam directed to an intermediate focus;
a debris mitigation device arranged near the intermediate focus and connected to a gas source, the debris mitigation device comprising a nozzle arranged to direct gas supplied by the source into a gas flow toward the radiation generating element or the radiation collector, the gas flow being sufficient to deflect or retard particulate debris moving toward the intermediate focus; and
an illumination system positioned after the intermediate focus and arranged to condition and direct the radiation beam onto a patterning means.

14. The lithographic apparatus of claim 13, wherein:
the vacuum chamber has a first aperture and a first cone-shaped wall section surrounding the first aperture;
the illumination system is contained within a second vacuum chamber having a second aperture and a second cone-shaped wall section surrounding the second aperture; and
the first and second cone-shaped wall sections are connected together to connect the vacuum chamber to the second vacuum chamber and allow the radiation beam to propagate to the illumination system.

15. A device manufacturing method using a lithographic apparatus, the method comprising:
generating radiation using a radiation source;
collecting the radiation and directing it to an intermediate focus to form a radiation beam;
imparting a pattern onto the radiation beam using a patterning means;
projecting the patterned radiation beam onto a substrate: and directing a flow of hydrogen towards the source from a nozzle located near the intermediate focus, the gas flow being sufficient to deflect or retard particulate debris moving toward the intermediate focus.
